(19) United States
(12) Patent Application Publication
(10) Pub. No.: US 2013/0076256 A1
(43) Pub. Date: Mar. 28, 2013

(54) LIGHT STRING WITHOUT USING A CONTROL BOX

(71) Applicant: Chen-Sheng YANG, Kaohsiung (TW)

(72) Inventor: Chen-Sheng YANG, Kaohsiung (TW)

(21) Appl. No.: 13/241,937

(22) Filed: Sep. 23, 2011

(51) Int. Cl. H05B 37/02

(52) U.S. Cl. 315/201

(57) ABSTRACT

A light string has a plug, a tail socket and multiple LED lamps connected between the plug and the tail socket. The plug and tail socket respectively have a voltage converting circuit to commonly form a power converting circuit that converts AC voltage to DC voltage. The LED lamps include a primary LED lamp and multiple secondary LED lamps, wherein the primary LED lamp has a primary control chip for outputting control data to each LED lamp. According to the control data, the LED lamps are able to generate different lighting effects without using an additional control box.

### BACKGROUND OF THE INVENTION

1. Field of the Invention

The invention relates to a decorative light string, and more particularly to a decorative light string that is able to provide variable lighting effects without using a control box.

2. Description of Related Art

With reference to FIG. 6, a conventional decorative light string comprises a power plug 51, a control box 52, a tail socket 53 and multiple lighting units 54.

The power plug 51 is adapted to connect to an AC power source to receive AC voltage.

The control box 52 is connected to the power plug to receive the AC voltage and has a circuit module for converting the AC voltage to DC voltage and outputting control signals to activate the lighting units 54. The control box 52 provides five wires, wherein three of them are connected to the lighting units 54 and others are connected to the tail socket 53.

The tail socket 53 is to be connected to a power plug 51 of another light string thus connecting different light strings in series to expand the number of the lighting units 54.

To control the lighting units 54 to generate different decorative effects, the control box 52 is an essential apparatus. However, the control box 52 will increase the complexity and the fabricating cost of the light string.

### SUMMARY OF THE INVENTION

A main objective of the present invention is to provide a light string that provides variable lighting effects without using a control box to simplify the structure of the light string and reduce the manufacturing cost.

The light string in accordance with the present invention includes a plug, a tail socket and multiple LED lamps connected between the plug and the tail socket. The plug and tail socket respectively have a voltage converting circuit to commonly form a power converting circuit that converts AC voltage to DC voltage. The LED lamps include a primary LED lamp and multiple secondary LED lamps, wherein the primary LED lamp has a primary control chip for outputting control data to each LED lamp through a signal wire. The LED lamps receive the DC voltage and are connected in sequence by the signal wire. Therefore, the LED lamps are able to generate different lighting effects according to the received control data without using an additional control box.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a light string in accordance with the present invention;

FIG. 2 is a plan view of the light string showing circuit boards mounted in LED lamps in accordance with the present invention;

FIG. 3 is a circuit diagram of the LED lamps in accordance with the present invention;

FIG. 4 is a circuit diagram of a preferred embodiment of a plug and a tail socket in accordance with the present invention;

FIG. 5 is a circuit diagram of another preferred embodiment of a plug and a tail socket in accordance with the present invention; and

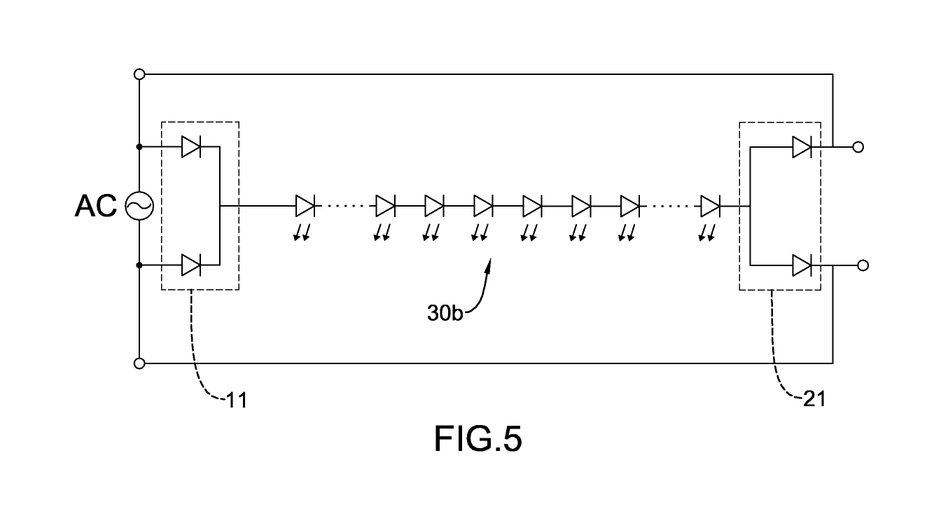

FIG. 6 is a plan view of a conventional light string.

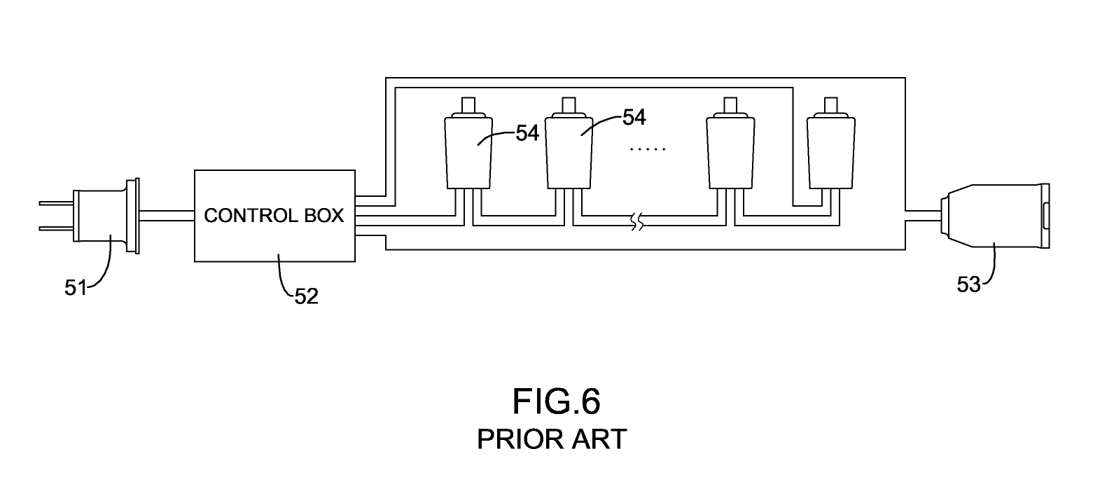

### DETAILED DESCRIPTION OF THE PREFERRED EMBODIMENT

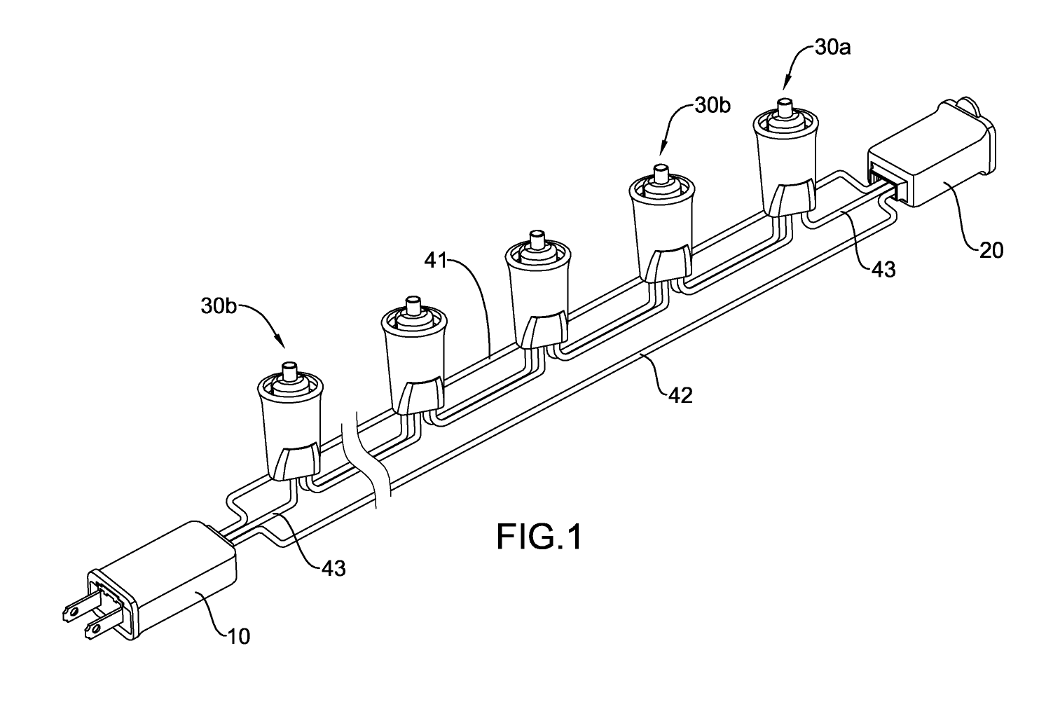

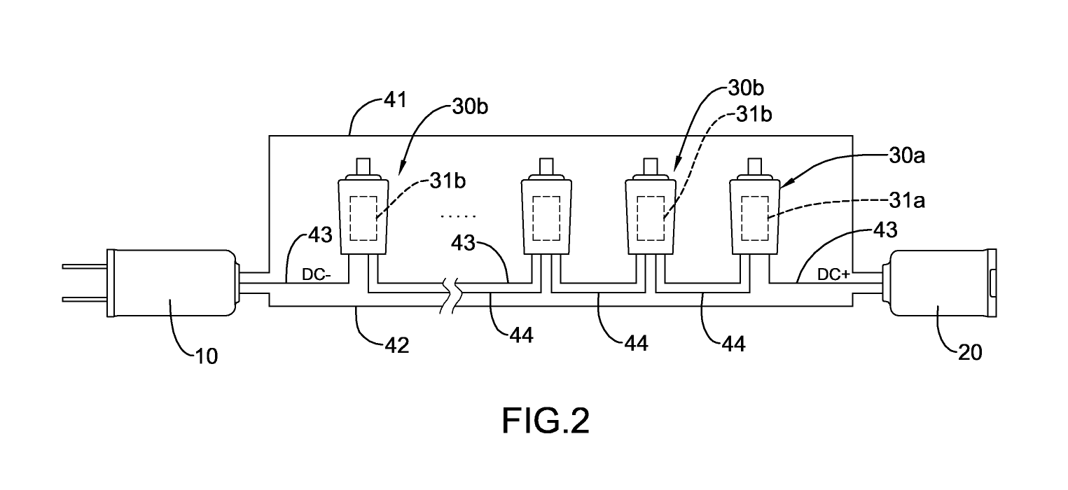

With reference to FIG. 1, a light string in accordance with the present invention comprises a plug 10, a tail socket 20 and multiple LED lamps 30a, 30b connected between the plug 10 and the tail socket 20. With further reference to FIG. 2, each of the LED lamps 30a, 30b has a circuit module 31a, 31b and multiple LEDs 34 of primary colors R, G and B.

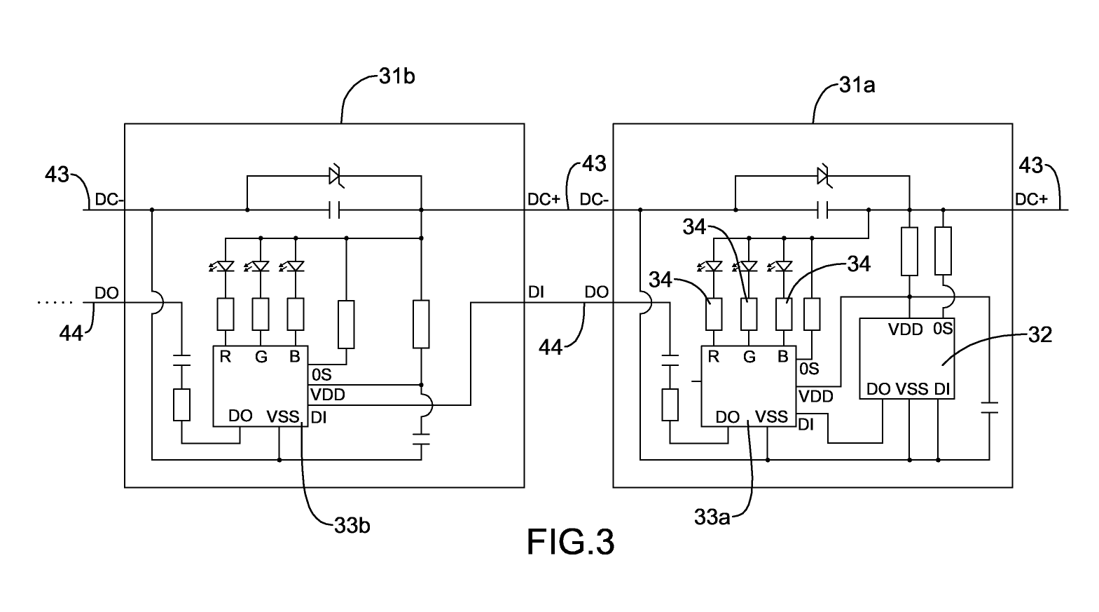

One of the LED lamps is designated as a primary LED lamp 30a and others are secondary LED lamps 30b. The circuit module 31a of the primary LED lamps 30a is different from other circuit modules 31b of the secondary LED lamps 30b. As shown in FIG. 3, the circuit module 31a of the primary LED lamp 30a includes a primary control chip 32 and a secondary control chip 33a. The circuit module 31b of the secondary LED lamp 30b only has the secondary control chip 33b.

The primary control chip 32 has a data output terminal (DO) and outputs control data from the output terminal (DO). Each secondary control chip 33a, 33b has a data input terminal (DI) and a data output terminal (DO). The data input terminal (DI) of a secondary control chip 33b is connected to the data output terminal (DO) of the primary control chip 32 or a previous secondary control chip 33a, 33b. Therefore, the primary control chip 32 and the secondary control chips 33a, 33b are sequentially connected. The primary control chip 32 will outputs a command to all secondary control chips 33a, 33b to sequentially and respectively designate the addresses. For example, the addresses of the control chips 33a, 33b can be 0001, 0002, 0003 . . . etc.

The LEDs 34 are connected to and controlled by the secondary control chips 33a, 33b based on the received control data from the primary control chip 32 to generate variable effects. For example, the LEDs 34 can emit light in different colors and produce a particular color by color mixing. The LEDs 34 also can be selectively or intermittently activated to generate twinkle effects. The activation of the LEDs 34 may be synchronous or asynchronous depending on the control data from the primary control chip 32.

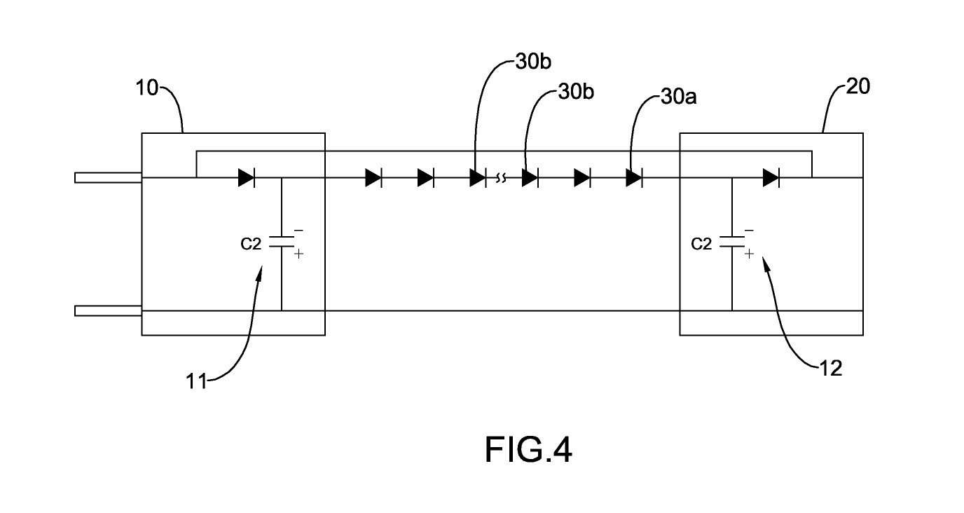

With further reference to FIG. 4, the plug 10 and the tail socket 20 respectively have a voltage converting circuit 11, 21 to commonly form a power converting circuit. Each voltage converting circuit 11, 21 includes a diode and a capacitor. The plug 10 can be inserted to an AC outlet to receive AC voltage. The power converting circuit converts the AC voltage to DC voltage. The DC voltage is transmitted to each LED lamp 30a, 30b. The power converting circuit is not limited to any specific type as long as it performs power conversion. For example, the power converting circuit can be a full bridge circuit, wherein two diodes are mounted in the plug 10 and the other two diodes are mounted in the tail socket 20. In another embodiment as shown in FIG. 4, the power converting circuit produces the DC voltage substantially twice a peak voltage of the AC voltage.

The light string in accordance with the present invention only uses four wires 41-44 to transmit power and control data between the plug 10, the tail socket 20 and the LED lamps 30a, 30b. The four wires consist of a first AC wire 41, a second AC wire 42, a DC wire 43 and a signal wire 44. The first and second AC wires 41, 42 extend from the plug 10 to the tail socket 20 for transmitting AC voltage to a subsequent light string connected to the tail socket 20. The DC wire 43 is connected between the plug 10 and the tail socket 20 and also electrically extends to each LED lamp 30a, 30b to provide the DC voltage for driving the LED lamps 30a, 30b. The signal wire 44 is connected to all LED lamps 30a, 30b in series to transmit the control data from the primary LED lamp 30a to other secondary LED lamps 30b. The control data contains the addresses information to select LED lamps 30a, 30b to be activated. For instance, if the addresses information includes the odd addresses, only the first, third, fifth . . . etc LED lamps will be turned on.

In conclusion, the light string in accordance with the present invention controls the LED lamps 30a, 30b by a primary circuit module 31a without using an additional control box and lowers the number of the wires connected among the plug 10, the tail socket 20 and the LED lamps 30a, 30b. Therefore, the fabricating cost and the possibility of light string breakdown resulted from the control box are reasonably reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light string without using a control box, comprising:
a plug receiving an AC voltage and having a first voltage converting circuit;
a tail socket having a second voltage converting circuit, wherein the first voltage converting circuit and the second voltage converting circuit commonly form a power converting circuit to convert the AC voltage to DC voltage;
multiple LED lamps electrically connected between the plug and the tail socket and including a primary LED lamp and multiple secondary LED lamps, wherein
the primary LED lamp has
a primary control chip having a data output terminal and outputting control data; and
a secondary control chip having a data input terminal connected to the data output terminal of the primary control chip and a data output terminal; and
each of the secondary LED lamps has
a secondary control chip having a data input terminal connected to the data output terminal of a previous secondary control chip, whereby all the secondary control chips and the primary control chip are connected in sequence;
multiple wires connected to the plug, the tail socket and the LED lamps and only consisting of
a first AC wire and a second AC wire connected between the plug and the tail socket for transmitting the AC voltage from the plug to the tail socket;
a DC wire connected between the plug and the tail socket and electrically connected to each LED lamp to provide the DC voltage; and
a signal wire connected to the LED lamps in series to transmit the control data from the primary LED lamp to other secondary LED lamps so as to control the LED lamps to produce variable effects according to the control data.

2. The light string as claimed in claim 1, wherein each of the LED lamps comprises multiple LEDs of primary colors.

3. The light string as claimed in claim 1, wherein the power converting circuit generates the DC voltage substantially twice a peak voltage of the AC voltage.

4. The light string as claimed in claim 2, wherein the power converting circuit generates the DC voltage substantially twice a peak voltage of the AC voltage.

5. The light string as claimed in claim 1, wherein the power converting circuit is a full bridge circuit.

6. The light string as claimed in claim 2, wherein the power converting circuit is a full bridge circuit.

7. The light string as claimed in claim 1, wherein the primary control chip outputs a command to sequentially and respectively designate addresses of the secondary control chips; and the control data includes addresses information for selecting LED lamps to be activated.
